(19) United States
(12) Patent Application Publication
(10) Pub. No.: US 2020/0347885 A1
(43) Pub. Date: Nov. 5, 2020

(54) EXTENDED SHAFT AND HOUSING INTERFACES FOR AXIAL BEARINGS

(71) Applicant: Schaeffler Technologies AG & Co. KG, Herzogenaurach (DE)

(72) Inventor: Michael Conlin, Rock Hill, SC (US)

(73) Assignee: Schaeffler Technologies AG & Co. KG, Herzogenaurach (DE)

(21) Appl. No.: 16/855,449

(22) Filed: Apr. 22, 2020

Related U.S. Application Data
(60) Provisional application No. 62/840,710, filed on Apr. 30, 2019.

(51) Int. Cl. F16C 35/063; F16C 19/26

(52) U.S. Cl. CPC F16C 35/063; F16C 19/26

(57) ABSTRACT

An axial bearing includes a shaft washer and a housing washer. An extension of the shaft interface is incorporated into the shaft washer and an extension of the housing interface is incorporated into the housing washer. As a result, the forces on the bearing are distributed more reliably to the shaft and housing, and the stresses internal to the bearing are more reliably and evenly distributed. This results in improved bearing performance and improved operating life. The bearing washer is more reliably located. The assembly is optimized in that mating components are potentially eliminated, and component dimensions are potentially reduced.

### CROSS-REFERENCE TO RELATED APPLICATIONS

This application claims priority to U.S. Provisional Application 62/840,710 filed Apr. 30, 2019, the entire disclosure of which is incorporated by reference herein.

### TECHNICAL FIELD

This disclosure concerns bearing assemblies. More particularly, the disclosure concerns axial thrust bearings having washers adapted for applications with limited housing and/or shaft abutments.

### BACKGROUND

Axial bearings transmit thrust between two components which are intended to experience relative rotation. In this disclosure, one of the two components, which may be stationary, is called the housing and the other component is called the shaft. Axial bearings rely on mating features, specifically abutments or other locating features, on the housing and the shaft to properly transmit forces. In many cases the abutments are not properly sized for the forces or for the configuration of the bearing. This results in poor bearing performance and early failure. The current means of rectifying the problem is to incorporate larger abutments than may be required to merely retain the bearing in place. This is not possible in all cases due to the physical constraints of the housing and shaft, and it is inefficient with respect to material as it requires larger stock than otherwise required.

### SUMMARY

An axial bearing assembly includes a housing washer, a shaft washer, and a plurality of rollers. The housing washer has a first extension protruding in a first axial direction and a radial locating feature protruding in a second axial direction opposite the first axial direction. The shaft washer has a second extension protruding in the first axial direction. The plurality of rollers separates the housing washer from the shaft washer and is located radially inside the first extension. The housing washer may define a groove on a radially outer surface to prevent relative rotation between a housing and the housing washer. A housing may have a first abutment in axial contact with the housing washer and in radial contact with the radial locating feature. The housing may also have a second abutment in axial contact with a tip of the first extension. The second abutment may radially overlap with the shaft washer and may axially overlap with the second extension. A shaft may have a third abutment in axial contact with the second extension. The rollers may be cylindrical.

### BRIEF DESCRIPTION OF THE DRAWINGS

FIG. 1 is a cross sectional view of an axial bearing assembly and mating parts.

FIG. 2 is a cross sectional view of a housing washer of the bearing assembly of FIG. 1.

FIG. 3 is a cross sectional view of a shaft washer of the bearing assembly of FIG. 1.

FIG. 4 is a detail view of FIG. 2.

FIG. 5 is a detail view of FIG. 3.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

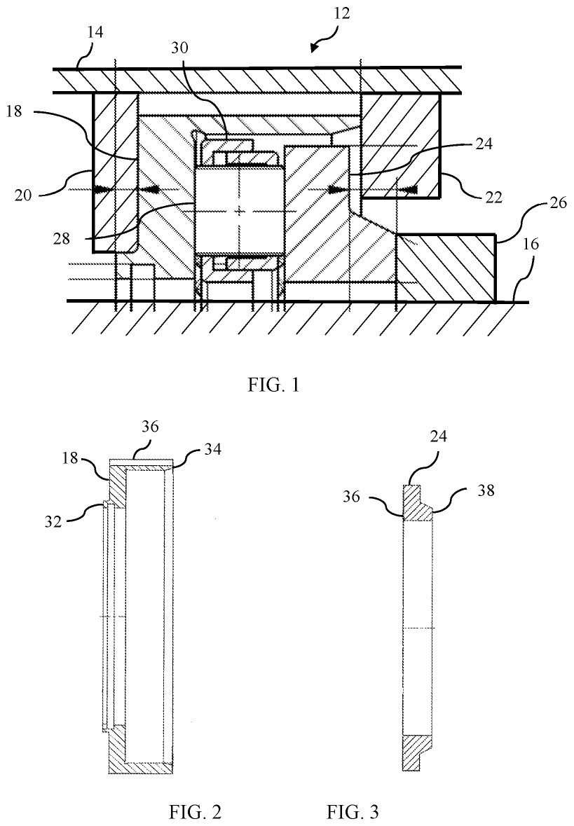

FIG. 1 illustrates an axial thrust bearing 12 between a hollow cylindrical housing 14 and a shaft 16. A housing washer 18 interfaces with stationary housing 14. Specifically, housing washer 18 is axially retained between spacers 20 and 22. Housing washer 18 is radially positioned with respect to spacer 20. A shaft washer 24 interfaces with rotatable shaft 16 via spacer 26. A set of rollers 28 axially separate housing washer 18 from shaft washer 24. Axial compressive forces are transmitted from shaft 16 to spacer 26 to shaft washer 24 to the rollers 28 to housing washer 18 to spacer 20 and finally to housing 14. A cage 30 positions the rollers radially and maintains circumferential spacing between them. The rolling action of the rollers facilitates relative rotation between the housing washer 18 and the shaft washer 24 with very low resistance. The bearing assembly 12 may be pre-assembled prior to assembly of the housing. bearing assembly, and shaft.

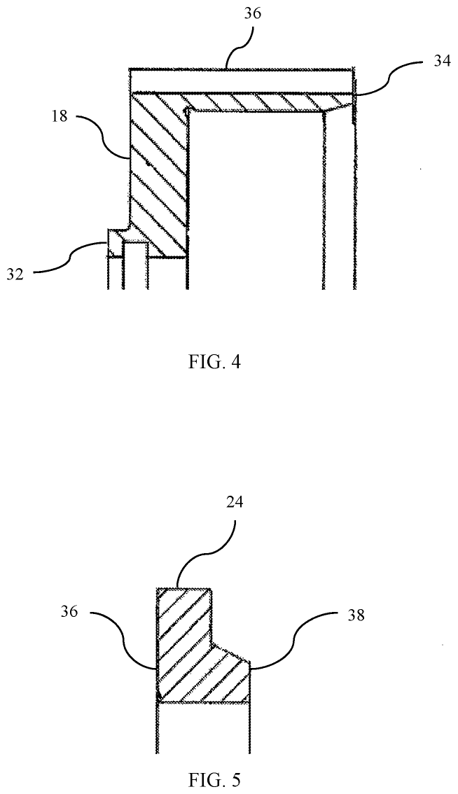

FIGS. 2 and 4 illustrate the housing washer. The dimensions of housing washer 18 are increased beyond the normal to transfer load more reliably from the rollers 28 to the housing 14 via spacer 20. The additional stiffness is integral to housing washer 18 as opposed to relying on spacer 20, increasing the reliability of the assembled bearing. Feature 32 radially locates the housing washer relative to spacer 20.

Extension 34 interfaces with spacer 22. A groove 36 in housing washer 18 interfaces with a mating feature in hollow housing 14 to prevent relative rotation between the housing and the housing washer. By incorporating an extension of the housing interface into the housing washer of the bearing, the forces on the bearing are distributed more reliably to the housing, and the stresses internal to the bearing are more reliably and evenly distributed. This results in improved bearing performance and improved operating life. The bearing washer is more reliably located. The assembly is optimized in that mating components are potentially eliminated, and component dimensions are potentially reduced.

FIGS. 3 and 5 illustrate the shaft washer. The dimensions of shaft washer 24 are increased beyond the normal at location 36 and/or location 38 in order to transfer load more reliably to the shaft of the mating structure. Unlike other common solutions to this problem, the extension is integral to shaft washer 24, increasing the strength and therefore the reliability of the assembled bearing.

By incorporating an extension of the shaft interface into the shaft washer of the bearing, the forces on the bearing are distributed more reliably to the shaft, and the stresses internal to the bearing are more reliably and evenly distributed. This results in improved bearing performance and improved operating life. The bearing washer is more reliably located. The assembly is optimized in that mating components are potentially eliminated, and component dimensions are potentially reduced.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

What is claimed is:

1. An axial bearing assembly comprising:
a housing washer having a first extension protruding in a first axial direction and a radial locating feature protruding in a second axial direction opposite the first axial direction;
a shaft washer having a second extension protruding in the first axial direction; and
a plurality of rollers separating the housing washer from the shaft washer and radially inside the first extension.

2. The axial bearing assembly of claim 1 wherein the housing washer defines a groove on a radially outer surface to prevent relative rotation between a housing and the housing washer.

3. The axial bearing assembly of claim 1 further comprising a housing, the housing having a first abutment in axial contact with the housing washer and in radial contact with the radial locating feature.

4. The axial bearing assembly of claim 3 wherein the housing has a second abutment in axial contact with a tip of the first extension.

5. The axial bearing assembly of claim 4 wherein the second abutment radially overlaps with the shaft washer.

6. The axial bearing assembly of claim 5 wherein the second abutment axially overlaps with the second extension.

7. The axial bearing assembly of claim 1 further comprising a shaft, the shaft having a third abutment in axial contact with the second extension.

8. The axial bearing assembly of claim 1 wherein the rollers are cylindrical.

9. An axial bearing comprising:
a shaft washer and a housing washer separated by a plurality of rollers;
wherein the shaft washer has a body in contact with the rollers and a first extension protruding away from the rollers to contact a shaft abutment; and
wherein the housing washer has a second extension protruding radially outside the rollers beyond the body of the shaft washer.

10. The axial bearing of claim 9 wherein the second extension defines a groove on a radially outer surface to prevent relative rotation between a housing and the housing washer.

11. The axial bearing of claim 9 wherein the housing washer has a radial locating feature protruding in a direction away from the rollers.

12. The axial bearing of claim 9 wherein the rollers are cylindrical.
